(19) United States
(12) Patent Application Publication
(10) Pub. No.: US 2025/0384835 A1
(43) Pub. Date: Dec. 18, 2025

(54) SUB-PIXEL, DISPLAY DEVICE INCLUDING THE SAME, AND ELECTRONIC DEVICE INCLUDING DISPLAY DEVICE

(71) Applicant: Samsung Display Co., LTD., Yongin-si (KR)

(72) Inventors: Dong Woo KIM, Yongin-si (KR); Kyung Bae KIM, Yongin-si (KR); Jin Joo HA, Yongin-si (KR)

(21) Appl. No.: 19/199,673

(22) Filed: May 6, 2025

(30) Foreign Application Priority Data
Jun. 17, 2024 (KR) 10-2024-0078092
Aug. 29, 2024 (KR) 10-2024-0116890

(51) Int. Cl. G09G 3/3233

(52) U.S. Cl. CPC G09G 3/3233; G09G 2300/0452; G09G 2300/0819; G09G 2300/0852; G09G 2300/0861; G09G 2310/08

(57) ABSTRACT

A sub-pixel may include a first transistor connected between a first node receiving a first power voltage and a second node, including a control electrode connected to a third node, and generating a driving current, a second transistor providing a data voltage to the third node in response to a first gate signal, a third transistor providing a ground voltage to the second node in response to a second gate signal, and a light emitting element emitting light by receiving the driving current, and including a first electrode connected to the second node and a second electrode receiving a second power voltage, wherein the third transistor may be configured as an NMOS transistor.

This application claims priority to Korean Patent Application No. 10-2024-0078092, filed on Jun. 17, 2024, and Korean Patent Application No. 10-2024-0116890, filed on Aug. 29, 2024, and all the benefits accruing therefrom under 35 U.S.C. § 119, the contents of which in their entirety are herein incorporated by reference.

### BACKGROUND

### 1. Field

The invention relates to a sub-pixel, and more particularly to a sub-pixel, a display device including the same electronic device including display device.

### 2. Description of the Related Art

As information technology develops, importance of a display device, which is a connection medium between a user and information, has been highlighted. In response to this, a use of a display device, such as a liquid crystal display device and an organic light emitting display device, is increasing.

Recently, a head mounted display device (HMD) is being developed. The HMD is a display device that is worn by a user in a form of glasses or a helmet and which implements a virtual reality (VR) or augmented reality (AR) environment in which a focus is formed at a distance that is located close to a user's eyes. A high-resolution panel is applied to the HMD, and thus a sub-pixel applicable to the high-resolution panel is required.

### SUMMARY

An object of the invention is to provide a sub-pixel and a display device including the sub-pixel applicable to a high-resolution panel.

According to an embodiment, a sub-pixel may include a first transistor connected between a first node receiving a first power voltage and a second node, including a control electrode connected to a third node, and generating a driving current, a second transistor providing a data voltage to the third node in response to a first gate signal, a third transistor providing a ground voltage to the second node in response to a second gate signal, and a light emitting element emitting light by receiving the driving current, and including a first electrode connected to the second node and a second electrode receiving a second power voltage, wherein the third transistor may be configured as an NMOS transistor.

In an embodiment, the sub-pixel may further include a fourth transistor providing the first power voltage to the first node in response to an emission signal.

In an embodiment, the sub-pixel may further include a first capacitor connected between the first node and the third node, a second capacitor connected between the third node and a gate electrode of the third transistor, and a third capacitor connected between the second node and the third node.

In an embodiment, each of the first to third capacitors may be configured as a metal-oxide metal (MOM) capacitor or a metal-insulator-metal (MIM) capacitor.

In an embodiment, each of the first and second capacitors may be configured as a metal-oxide metal (MOM) capacitor or a metal-insulator-metal (MIM) capacitor, and the third capacitor may be configured as a parasitic capacitor.

In an embodiment, each of the first transistor, the second transistor, and the fourth transistors may be configured as a PMOS transistor.

In an embodiment, the first power voltage may be supplied to a body electrode of each of the first transistor, the second transistor, and the fourth transistor, and the ground voltage may be supplied to a body electrode of the third transistor.

In an embodiment, one horizontal period may include a first period, a second period, and a third period, where each of the second to fourth transistors may be turned on during the first period, the second transistor and the third transistor may be turned on and the fourth transistor is turned off during the second period, and the third transistor and the fourth transistor may be turned on and the second transistor is turned off during the third period.

In an embodiment, the sub-pixel may further include a first capacitor connected between the first node and the third node, a second capacitor connected between the third node and a node receiving a reference voltage, and a third capacitor connected between the second node and the third node, wherein the reference voltage may be less than the first power voltage and greater than the second power voltage.

In an embodiment, the sub-pixel may further include a first capacitor connected between the first node and the third node, a second capacitor connected between the third node and a node receiving the first power voltage, and a third capacitor connected between the second node and the third node.

According to an embodiment, a display device may include a display panel including a sub-pixel, and a display panel driver configured to drive the display panel, where the sub-pixel may include a first transistor connected between a first node receiving a first power voltage and a second node, including a control electrode connected to a third node, and generating a driving current, a second transistor providing a data voltage to the third node in response to a first gate signal, a third transistor providing a ground voltage to the second node in response to a second gate signal, and a light emitting element emitting light by receiving the driving current, and including a first electrode connected to the second node and a second electrode receiving a second power voltage, wherein the third transistor may be configured as an NMOS transistor.

In an embodiment, the sub-pixel may further include a fourth transistor providing the first power voltage to the first node in response to an emission signal.

In an embodiment, the sub-pixel may further include a first capacitor connected between the first node and the third node, a second capacitor connected between the third node and a gate electrode of the third transistor, and a third capacitor connected between the second node and the third node.

In an embodiment, each of the first to third capacitors may be configured as a metal-oxide metal (MOM) capacitor or a metal-insulator-metal (MIM) capacitor.

In an embodiment, each of the first and second capacitors may be configured as a metal-oxide metal (MOM) capacitor or a metal-insulator-metal (MIM) capacitor, wherein the third capacitor may be configured as a parasitic capacitor.

In an embodiment, each of the first transistor, the second transistor, and the fourth transistor may be configured as a PMOS transistor.

In an embodiment, the first power voltage may be supplied to a body electrode of each of the first transistor, the second transistor, and the fourth transistor, wherein the ground voltage may be supplied to a body electrode of the third transistor. In an embodiment, one horizontal period may include a first period, a second period, and a third period, wherein each of the second to fourth transistors may be turned on during the first period, the second transistor and the third transistor may be turned on and the fourth transistor is turned off during the second period, and the third transistor and the fourth transistor may be turned on and the second transistor is turned off during the third period.

In an embodiment, the sub-pixel may further include a first capacitor connected between the first node and the third node, a second capacitor connected between the third node and a node receiving a reference voltage, and a third capacitor connected between the second node and the third node, wherein the reference voltage may be less than the first power voltage and greater than the second power voltage.

In an embodiment, the sub-pixel may further include a first capacitor connected between the first node and the third node, a second capacitor connected between the third node and a node receiving the first power voltage, and a third capacitor connected between the second node and the third node.

According to an embodiment, a sub-pixel having a high luminance while securing a contrast ratio may be provided.

However, an effect of the invention is not limited to the above-described effect, and may be variously expanded without departing from the spirit and scope of the invention.

### BRIEF DESCRIPTION OF THE DRAWINGS

The above and other features of the invention will become more apparent by describing in further detail embodiments thereof with reference to the accompanying drawings, in which:

FIG. 1 is a block diagram illustrating a display device, according to an embodiment;

FIG. 2 is a circuit diagram illustrating an example of a sub-pixel of the display device of FIG. 1, according to an embodiment;

FIG. 3 is a timing diagram illustrating an embodiment of a method of driving the sub-pixel shown in FIG. 2, according to an embodiment;

FIG. 4 is a circuit diagram illustrating an operation process of the sub-pixel according to signals of FIG. 3, according to an embodiment;

FIG. 5 is a circuit diagram illustrating an operation process of the sub-pixel according to signals of FIG. 3, according to an embodiment;

FIG. 6 is a circuit diagram illustrating an operation process of the sub-pixel according to signals of FIG. 3, according to an embodiment;

FIG. 7 is a circuit diagram illustrating an operation process of the sub-pixel according to signals of FIG. 3, according to an embodiment;

FIG. 8 is a circuit diagram illustrating another example of the sub-pixel of the display device of FIG. 1, according to an embodiment;

FIG. 9 is a circuit diagram illustrating another example of the sub-pixel of the display device of FIG. 1, according to an embodiment;

FIG. 10 is a block diagram illustrating an electronic device, according to an embodiment; and

FIG. 11 is a diagram illustrating an example in which the electronic device of FIG. 10 is implemented as a smartphone, according to an embodiment.

### DETAILED DESCRIPTION

Hereinafter, an embodiment is described in detail with reference to the accompanying drawings. It should be noted that in the following description, only portions necessary for understanding an operation according to the disclosure are described, and descriptions of other portions are omitted in order not to obscure the invention. In addition, the invention may be embodied in other forms without being limited to the embodiment(s) described herein. However, the embodiment(s) described herein is/are provided to describe in detail enough to easily implement the technical spirit of the invention to those skilled in the art to which the invention belongs.

Throughout the specification, in a case where a portion is “connected” to another portion, the case includes not only a case where the portion is “directly connected” but also a case where the portion is “indirectly connected” with another element interposed therebetween. Terms used herein are for describing specific embodiments and are not intended to limit the invention. Throughout the specification, in a case where a certain portion “includes”, the case means that the portion may further include another component without excluding another component unless otherwise stated. “At least any one of X, Y, and Z” and “at least any one selected from a group consisting of X, Y, and Z” may be interpreted as one X, one Y, one Z, or any combination of two or more of X, Y, and Z (for example, XYZ, XYY, YZ, and ZZ). Here, “and/or” includes all combinations of one or more of corresponding configurations.

Here, terms such as first and second may be used to describe various components, but these components are not limited to these terms. These terms are used to distinguish one component from another component. Therefore, a first component may refer to a second component within a range without departing from the scope disclosed herein.

Spatially relative terms such as “under”, “on”, and the like may be used for descriptive purposes, thereby describing a relationship between one element or feature and another element(s) or feature(s) as shown in the drawings. Spatially relative terms are intended to include other directions in use, in operation, and/or in manufacturing, in addition to the direction depicted in the drawings. For example, when a device shown in the drawing is turned upside down, elements depicted as being positioned “under” other elements or features are positioned in a direction “on” the other elements or features. Therefore, in an embodiment, the term “under” may include both directions of on and under. In addition, the device may face in other directions (for example, rotated 90 degrees or in other directions) and thus the spatially relative terms used herein are interpreted according thereto.

Various embodiments are described with reference to drawings schematically illustrating ideal embodiments. Accordingly, it will be expected that shapes may vary, for example, according to tolerances and/or manufacturing techniques. Therefore, the embodiments disclosed herein cannot be construed as being limited to shown specific shapes, and should be interpreted as including, for example, changes in shapes that occur as a result of manufacturing. As described above, the shapes shown in the drawings may not show actual shapes of areas of a device, and the invention is not limited thereto.

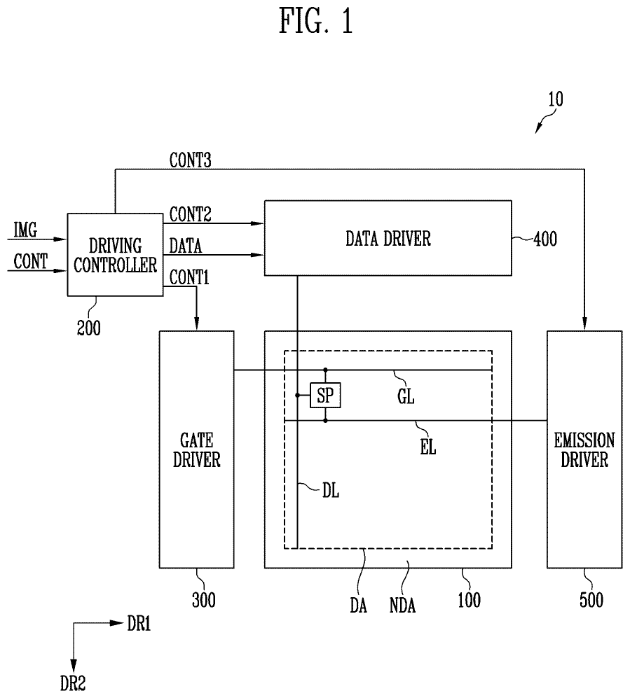

FIG. 1 is a block diagram illustrating a display device, according to an embodiment.

In an embodiment and referring to FIG. 1, the display device 10 may include a display panel 100 and a display panel driver. The display panel driver may include a driving controller 200, a gate driver 300, a data driver 400, and an emission driver 500. In an embodiment, the driving controller 200 and the data driver 400 may be integrated into one chip.

In an embodiment, the display panel 100 may include a display area DA that displays an image and a non-display area NDA disposed adjacent to the display area DA. In an embodiment, the gate driver 300 and the emission driver 500 may be mounted in the non-display area NDA.

In an embodiment, the display panel 100 may include a plurality of gate lines GL, a plurality of data lines DL, a plurality of emission lines EL, and a plurality of sub-pixels SP electrically connected to the gate lines GL, the data lines DL, and the emission lines EL. The gate lines GL and the emission lines EL may extend in a first direction DR1, and the data lines DL may extend in a second direction DR2 intersecting the first direction DR1.

In an embodiment, the driving controller 200 may receive input image data IMG and an input control signal CONT from a main processor (for example, a graphic processing unit (GPU) or the like. For example, the input image data IMG may include red image data, green image data, and blue image data. In an embodiment, the input image data IMG may further include white image data. As another example, the input image data IMG may include magenta image data, yellow image data, and cyan image data. The input control signal CONT may include a master clock signal and a data enable signal. The input control signal CONT may further include a vertical synchronization signal and a horizontal synchronization signal.

In an embodiment, the driving controller 200 may generate a first control signal CONT1, a second control signal CONT2, a third control signal CONT3 and a data signal DATA based on the input image data IMG and the input control signal CONT.

In an embodiment, the driving controller 200 may generate the first control signal CONT1 for controlling an operation of the gate driver 300 based on the input control signal CONT and output the first control signal CONT1 to the gate driver 300. The first control signal CONT1 may include a vertical start signal and a gate clock signal.

In an embodiment, the driving controller 200 may generate the second control signal CONT2 for controlling an operation of the data driver 400 based on the input control signal CONT and output the second control signal CONT2 to the data driver 400. The second control signal CONT2 may include a horizontal start signal and a load signal.

In an embodiment, the driving controller 200 may receive the input image data IMG and the input control signal CONT to generate the data signal DATA. The driving controller 200 may output the data signal DATA to the data driver 400.

In an embodiment, the driving controller 200 may generate the third control signal CONT3 for controlling an operation of the emission driver 500 based on the input control signal CONT and output the third control signal CONT3 to the emission driver 500. The third control signal CONT3 may include a vertical start signal and an emission clock signal.

In an embodiment, the gate driver 300 may generate gate signals for driving the gate lines GL in response to the first control signal CONT1 received from the driving controller 200. The gate driver 300 may output the gate signals to the gate lines GL. For example, the gate driver 300 may sequentially output the gate signals to the gate lines GL.

In an embodiment, the data driver 400 may receive the second control signal CONT2 and the data signal DATA from the driving controller 200. The data driver 400 may generate data voltages obtained by converting the data signal DATA into an analog voltage. The data driver 400 may output the data voltages to the data line DL.

In an embodiment, the emission driver 500 may generate emission signals for driving the emission lines EL in response to the third control signal CONT3 received from the driving controller 200. The emission driver 500 may output the emission signals to the emission lines EL. For example, the emission driver 500 may sequentially output the emission signals to the emission lines EL.

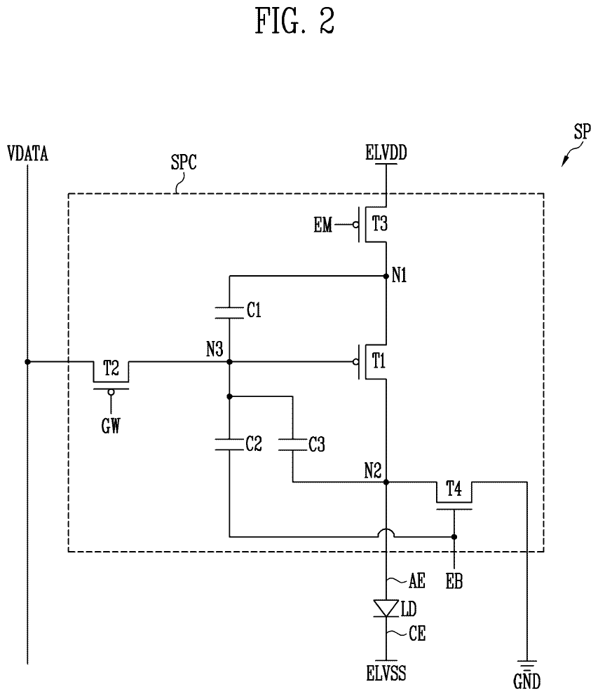

FIG. 2 is a circuit diagram illustrating an example of a sub-pixel of the display device of FIG. 1, according to an embodiment.

In an embodiment and referring to FIG. 2, the sub-pixel SP may include a light emitting element LD and a sub-pixel circuit SPC for controlling a current amount supplied to the light emitting element LD.

In an embodiment, the light emitting element LD may be selected as an organic light emitting diode. In addition, the light emitting element LD may be selected as an inorganic light emitting diode such as a micro light emitting diode (LED) or a quantum dot light emitting diode. In addition, the light emitting element LD may be an element configured of a composite of an organic material and an inorganic material. In FIG. 2, the sub-pixel SP is shown as including a single light emitting element LD, but in another embodiment, the sub-pixel SP may include a plurality of light emitting elements LD, and the plurality of light emitting elements LD may be connected to each other in series, parallel, or series-parallel.

In an embodiment, the sub-pixel circuit SPC may include a first transistor T1, a second transistor T2, a third transistor T3, a fourth transistor T4, a first capacitor C1, a second capacitor C2, and a third capacitor C3.

In an embodiment, the first transistor T1 to the fourth transistor T4 may be transistors including a body electrode. For example, each of the transistors T1 to T4 may be a metal oxide semiconductor field effect transistor (MOSFET). In this case, the first transistor T1 to the fourth transistor T4 may be mounted in a narrow area, and thus the sub-pixel SP may be applied to a high-resolution panel. The body electrodes of the first transistor T1 to the third transistor T3 may receive a first power voltage ELVDD, and the body electrode of the fourth transistor T4 may receive a ground voltage GND.

In an embodiment, each of the transistors T1 to T3 may be configured as a p-channel metal oxide semiconductor (PMOS) transistor. In this case, a low voltage level may be an activation level, and a high voltage level may be a deactivation level. For example, when a signal applied to a control electrode of the PMOS transistor has the low voltage level, the PMOS transistor may be turned on. For example, when a signal applied to the control electrode of the PMOS transistor has the high voltage level, the PMOS transistor may be turned off.

In an embodiment, the fourth transistor T4 may be configured as an n-channel metal oxide semiconductor (NMOS) transistor. In this case, a low voltage level may be a deactivation level, and a high voltage level may be an activation level. For example, when a signal applied to a control electrode of the NMOS transistor has the low voltage level, the NMOS transistor may be turned off. For example, when a signal applied to the control electrode of the NMOS transistor has the high voltage level, the NMOS transistor may be turned on.

In an embodiment, a first electrode of the first transistor T1 may be connected to a first node N1, and a second electrode may be connected to a second node N2. Here, ‘being connected’ includes being electrically connected. A gate electrode of the first transistor T1 may be connected to a third node N3. The first node N1 means a node to which a second electrode of the third transistor T3 is connected, and the second node N2 may mean a node to which a first electrode of the light emitting element LD is connected. The first transistor T1 may control a current amount supplied from the first power voltage ELVDD (for example, a high power voltage) to a second power voltage ELVSS (for example, a low power voltage) via the light emitting element LD in response to a voltage of the third node N3.

In an embodiment, the second transistor T2 may include a control electrode receiving a first gate signal GW, a first electrode receiving a data voltage VDATA, and a second electrode connected to the third node N3.

In an embodiment, the third transistor T3 may include a control electrode receiving an emission signal EM, a first electrode receiving the first power voltage ELVDD, and a second electrode connected to the first node N1.

In an embodiment, the fourth transistor T4 may include a control electrode receiving a second gate signal EB, a first electrode connected to the second node N2, and a second electrode receiving the ground voltage GND. In an embodiment, the ground voltage GND may be 0 V.

In an embodiment, the first capacitor C1 may be connected between the first node N1 and the third node N3. The first capacitor C1 may be driven as a coupling capacitor and may transmit a voltage change amount of the first node N1 to the third node N3. In addition, the first capacitor C1 may store the voltage of the third node N3.

In an embodiment, the second capacitor C2 may be connected between the third node N3 and a gate line to which the second gate signal EB is applied. That is, the second capacitor C2 may be connected between the third node and a gate electrode of the fourth transistor T4.

In an embodiment, the third capacitor C3 may be connected between the second node N2 and the third node N3. The third capacitor C3 may be driven as a coupling capacitor and may transmit a voltage change amount of the second node N2 to the third node N3.

In an embodiment, each of the capacitors C1 to C3 may be configured as a metal-oxide metal (MOM) capacitor or a metal-insulator-metal (MIM) capacitor.

In an embodiment, each of the capacitors C1 and C2 may be configured as an MOM capacitor or an MIM capacitor, and the third capacitor C3 may be configured as a parasitic capacitor.

In an embodiment, the light emitting element LD may include an anode electrode AE connected to the second node N2 and a cathode electrode CE receiving the second power voltage ELVSS.

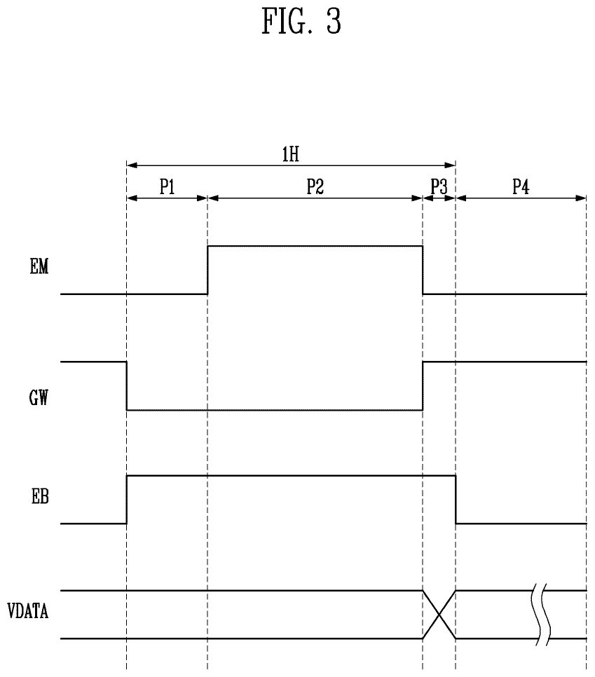

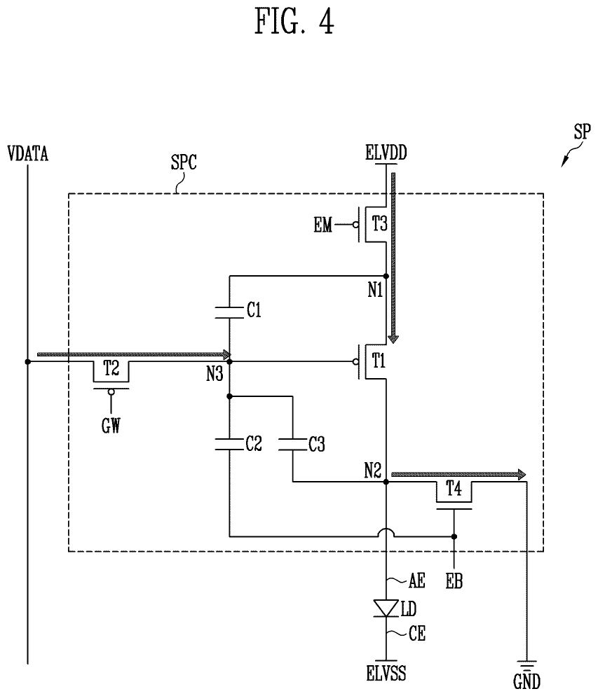

FIG. 3 is a timing diagram illustrating an embodiment of a method of driving the sub-pixel shown in FIG. 2, according to an embodiment. FIGS. 4 to 7 are circuit diagrams illustrating an operation process of the sub-pixel according to signals of FIG. 3, according to an embodiment.

In an embodiment and referring to FIG. 3, a horizontal period 1H (or a specific horizontal period) in which the data signal is supplied to the sub-pixel SP may be divided into a first period P1, a second period P2, and a third period P3. A start time point of the second period P2 may be after an end time point of the first period P1. A start time point of the third period P3 may be after an end time point of the second period P2.

In an embodiment, after the horizontal period 1H, a fourth period P4 in which the light emitting element LD emits light may be started, where a start time point of the fourth period P4 may be after an end time point of the third period P3.

In an embodiment and referring to FIGS. 3 and 4, in the first period P1, the first gate signal GW, the second gate signal EB, and the emission signal EM have the activation level, and the transistors T2 to T4 may be turned on.

In an embodiment, during the first period P1, the first power voltage ELVDD may be applied to the first node N1, the ground voltage GND may be applied to the second node N2, and the voltage VDATA of the data signal may be applied to the third node N3.

At this time, in an embodiment, the first capacitor C1 may be initialized by the voltage VDATA of the data signal and the first power voltage ELVDD. For example, the first capacitor C1 may charge the voltage VDATA of the data signal and the first power voltage ELVDD regardless of a voltage charged in a previous period (or a previous frame period) during the first period P1.

In an embodiment, the second capacitor C2 may charge the voltage VDATA of the data signal and a voltage of the second gate signal EB regardless of a voltage charged in the previous period (or the previous frame period) during the first period P1.

In an embodiment, the third capacitor C3 may charge the voltage VDATA of the data signal and the ground voltage GND regardless of a voltage charged in the previous period (or the previous frame period) during the first period P1.

That is, the first capacitor C1, the second capacitor C2, and the third capacitor C3 may be initialized during the first period P1. The first period P1 may be referred to as an initialization period and a data signal write period.

In an embodiment, during the first period P1, a current supplied from the first transistor T1 correspondingly to the voltage of the third node N3 is supplied as the ground voltage GND via the fourth transistor T4, and thus a voltage of the second node N2 may be the ground voltage GND. Therefore, the light emitting element LD may maintain a non-emission state during the first period P1.

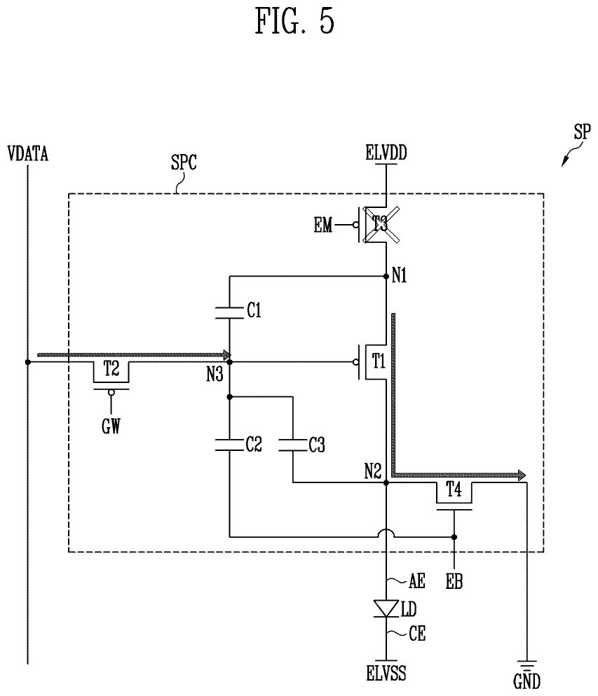

In an embodiment and referring to FIG. 3 and FIG. 5, in the second period P2, the first gate signal GW and the second gate signal EB may have the activation level, and the second and fourth transistors T2 and T4, respectively may be turned on. In addition, in the second period P2, the emission signal EM may have the deactivation level, and the third transistor T3 may be turned off.

In an embodiment, since the second transistor T2 is turned on during the second period P2, the voltage VDATA of the data signal is supplied to the third node N3. Accordingly, a voltage corresponding to a threshold voltage of the first transistor T1 may be stored in the first capacitor C1 during the second period P2. In addition, a voltage of the first node N1 may be lowered from the first power voltage ELVDD to a voltage (VDATA+|Vth(T1)|) that is obtained by adding an absolute threshold voltage of the first transistor T1 to the voltage VDATA of the data signal.

That is, in an embodiment, during the second period P2, the third node N3 may be set to the voltage VDATA of the data signal, and the first node N1 may be set to the voltage (VDATA+|Vth(T1)|) obtained by adding the absolute threshold voltage of the first transistor T1 to the voltage VDATA of the data signal. Therefore, during the second period P2, the threshold voltage of the first transistor T1 may be stored in the first capacitor C1. The second period P2 may be referred to as a first threshold voltage compensation period.

In an embodiment, since the fourth transistor T4 is turned on during the second period P2, a current supplied from the first node N1 to the second node N2 via the first transistor T1 is supplied to the ground voltage GND via the fourth transistor T4, and thus the voltage of the second node N2 may be the ground voltage GND. Therefore, the light emitting element LD may maintain the non-emission state during the second period P2.

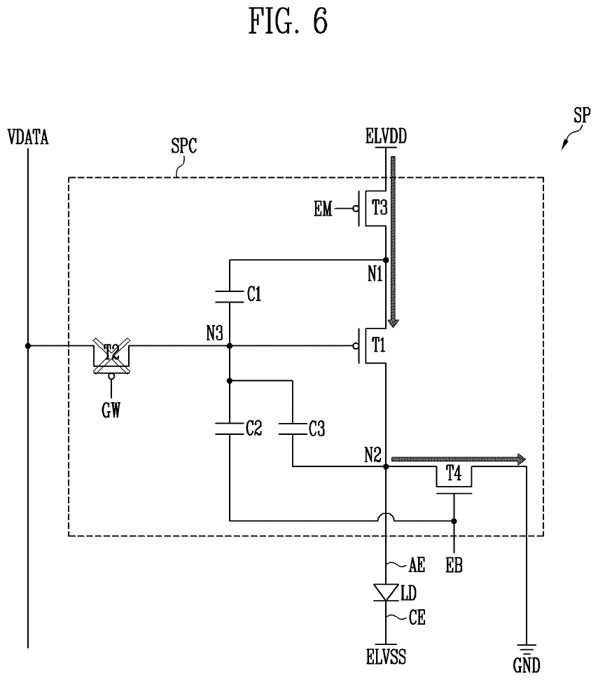

In an embodiment and referring to FIGS. 3 and 6, in the third period P3, the second gate signal EB may have the activation level, and the fourth transistor T4 may be turned on. In addition, in the third period P3, the first gate signal GW and the emission signal EM may have the deactivation level, and the second and third transistors T2 and T3, respectively, may be turned off.

In an embodiment, during the third period P3, the first transistor T1 controls a current amount supplied from the first power voltage ELVDD to the ground voltage GND correspondingly to the voltage of the third node N3.

As the third transistor T3 is turned on, the first power voltage ELVDD is supplied to the first node N1, and as the second transistor T2 is turned off, supply of the voltage VDATA of the data signal to the third node N3 is stopped.

Accordingly, in an embodiment, the voltage of the third node N3 may be a sum of the voltage VDATA of the data signal and a value (α(ELVDD−(VDATA+|Vth(T1)|))) that reflects a difference between the voltage of the first node N1 and the first power voltage ELVDD during the second period P2.

In an embodiment, the first transistor T1 controls a current amount supplied from the first power voltage ELVDD to the second node N2 corresponding to a voltage applied to the third node N3. The third period P3 may be referred to as a luminance control period.

At this time, in an embodiment, since the fourth transistor T4 is set to a turn-on state, a current supplied to the second node N2 may be supplied to the ground voltage GND, and thus voltage of the second node N2 may be the ground voltage GND.

In an embodiment, when the fourth transistor T4 is configured as a PMOS transistor to which the first power voltage ELVDD is supplied to the body electrode, the voltage of the second node N2 may be set higher than the ground voltage GND due to the body effect. In contrast, when the fourth transistor T4 is configured as an NMOS transistor to which the ground voltage GND is supplied to the body electrode as in the present embodiment, the voltage of the second node N2 may be set to the ground voltage GND.

In an embodiment, when the fourth transistor T4 is configured as the NMOS transistor as in the present embodiment, since a voltage level of the second power voltage may be set lower than that when the fourth transistor T4 is configured as a PMOS transistor, a sub-pixel having a high luminance while securing a contrast ratio may be provided. That is, accurate grayscale expression of the display device 10 may be possible.

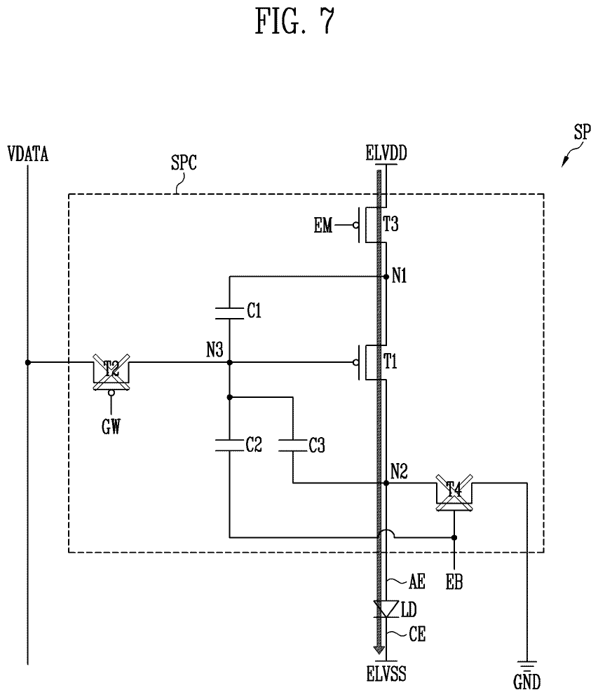

In an embodiment and referring to FIGS. 3 and 7, in the fourth period P4, the emission signal EM may have the activation level, and the third transistor T3 may be turned on. In addition, in the fourth period P4, the first gate signal GW and the second gate signal EB may have the deactivation level, and the second and fourth transistors T2 and T4 may be turned off.

In an embodiment, during the fourth period P4, the first transistor T1 controls a current amount flowing from the first power voltage ELVDD to the second power voltage ELVSS via the light emitting element LD corresponding to the voltage of the third node N3. In this case, during the fourth period P4, the light emitting element LD may emit light with a luminance corresponding to a current amount supplied from the first transistor T1. This fourth period P4 may be referred to as a light emission period.

With reference to FIGS. 4 to 7, a threshold voltage compensation process, according to an embodiment, is described in detail.

First, in an embodiment and referring to FIG. 4, the threshold voltage of the first transistor T1 may be determined by a voltage difference between the body electrode and a source electrode (for example, the first node N1). For example, when it is assumed that the first power voltage ELVDD is set to about 8 V, during the second period P2, the body electrode of the first transistor T1 may be set to about 8 V, and the source electrode may be set to a voltage lower than that of the body electrode.

In an embodiment, when it is assumed that the first node N1 is set to about 4 V, the voltage difference between the body electrode and the source electrode of the first transistor T1 may be set to about 4 V (for example, VBS=4 V). At this time, the first transistor T1 may have a first threshold voltage corresponding to about 4 V, which is the voltage difference between the body electrode and the source electrode.

In an embodiment, the first threshold voltage may be compensated for during the second period P2. For example, during the second period P2, the third node N3 is set to the voltage VDATA of the data signal, and the first node N1 is set to the voltage obtained by adding the absolute threshold voltage of the first transistor T1 (VDATA+|Vth(T1)| to the voltage VDATA of the data signal. The threshold voltage of the first transistor T1 may be stored in the first capacitor C1.

As described above, according to an embodiment, the threshold voltage of the first transistor T1 may be firstly compensated during the second period P2. For example, after the second period P2, the third transistor T3 may be turned on, and the threshold voltage reflected to the first node N1 may be reflected to the voltage of the third node N3, and turn-on and/or turn-off of the first transistor T1 may be controlled according to the voltage of the third node N3. Accordingly, the first threshold voltage of the first transistor T1 may be compensated.

Meanwhile, in an embodiment and referring to FIG. 6, during the third period P3, the first node N1 may be set to the first power voltage ELVDD. Accordingly, the source electrode of the first transistor T1 may have the same voltage as the body electrode. For example, the voltage difference between the source electrode and the body electrode of the first transistor T1 may be about 0 V. According to a changed voltage difference between the body electrode and the source electrode of the first transistor T1, the first transistor T1 may have a second threshold voltage different from the first threshold voltage.

In an embodiment, when the first power voltage ELVDD is supplied to the first node N1 during the third period P3, the voltage of the third node N3 may change according to a voltage change of the first node N1. In an embodiment, the voltage of the third node N3 may be set as shown immediately below in Formula 1:

$$VN 3 a ∝ VDATA + ( VDD - ( VDATA + \vert Vth ( T 1 ) \vert ) ) \times c 1 / ( c 1 + c 2 + c 3 ) , \qquad [ Formula 1 ]$$

where, VN3a may represent the voltage of the third node N3, c1 may be a capacitance value of the first capacitor C1, c2 may be a capacitance value of the second capacitor C2, and c3 may be a capacitance value of the third capacitor C3.

In an embodiment, as the first power voltage ELVDD is provided to the first node N1 during the third period P3, the voltage of the first node N1 during the third period P3 may change from the voltage (VDATA+|Vth(T1)| obtained by adding the voltage VDATA of the data signal and the absolute threshold voltage (|Vth(T1)|) of the first transistor T1 to the first power voltage ELVDD. Therefore, VDD−(VDATA+|Vth(T1)| may represent the voltage change amount of the first node N1.

In an embodiment, the voltage of the third node N3 may also be changed by coupling of the first capacitor C1. A voltage change amount of the third node N3 may be determined according to a ratio of the first capacitor C1, the second capacitor C2, and the third capacitor C3.

In an embodiment, the second capacitor C2 adjusts a ratio in which the voltage change amount of the first node N1 is reflected to a voltage change amount of the second node N2. For example, as the second capacitor C2 increases, the voltage change amount of the third node N3 may decrease with respect to the voltage change amount of the first node N1. In this case, a voltage range of the data signal may be selected to be more suitable for the display device 10.

In an embodiment, after the voltage of the third node N3 is set as in shown in Formula 1 hereinabove, a current amount supplied to the second node N2 through the first transistor T1 corresponding to the voltage of the third node N3 may vary. Accordingly, a voltage of an anode electrode (for example, the second node N2) of the first transistor T1 may be changed.

In an embodiment, the second node N2 and the third node N3 are connected through the third capacitor C3. The voltage of the third node N3 may be further changed according to the voltage change amount of the second node N2. For example, the voltage of the third node N3 may be changed by coupling of the third capacitor C3.

$$VN 3 b ∝ VN 3 a + Δ VN 2 \times c 3 / ( c 1 + c 2 + c 3 ) , \qquad [ Formula 2 ]$$

where, ΔVN2 may represent the voltage change amount of the second node N2, and VN3b may represent the voltage of the third node N3 corresponding to the voltage change amount (ΔVN2) of the second node N2. As shown in Formula 2, the voltage of the third node N3 may be determined as a sum of a value obtained by multiplying the voltage change amount (ΔVN2) of the second node N2 by C3/(C1+C2+C3) and VN3a of Formula 1.

According to an embodiment, the threshold voltage of the first transistor T1 may be secondly compensated by reflecting the voltage change amount (ΔVN2) of the second node N2 to the voltage of the third node N3 through the third capacitor C3.

In an embodiment, the voltage change amount (ΔVN2) of the second node N2 may be set corresponding to a threshold voltage change of the first transistor T1. For example, the voltage change amount (ΔVN2) of the second node N2 may be determined differently corresponding to a change from the first threshold voltage of the first transistor T1 to the second threshold voltage. For example, the voltage change amount (ΔVN2) of the second node N2 may reflect the second threshold voltage of the first transistor T1.

In an embodiment, according to the voltage change amount (ΔVN2) of the second node N2, the voltage of the third node N3 may experience further changes, and thus the first transistor T1 may be turned on and/or turned off. Accordingly, the second threshold voltage of the first transistor T1 may be compensated.

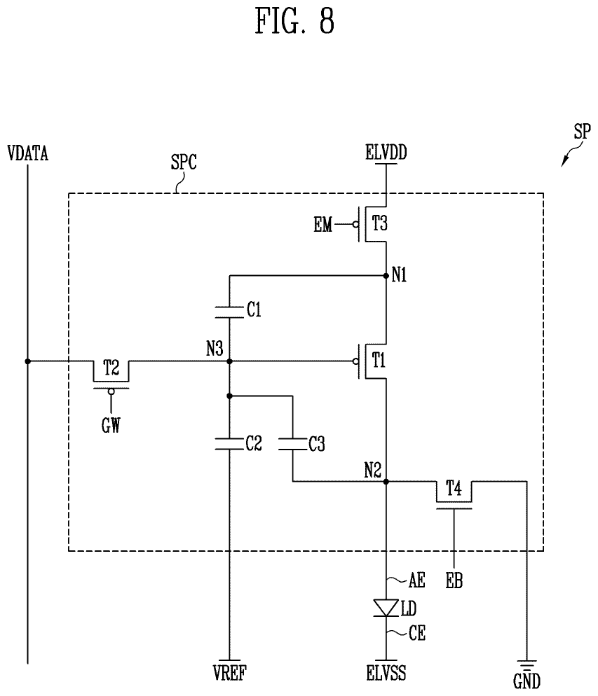

FIG. 8 is a circuit diagram illustrating another example of the sub-pixel of the display device of FIG. 1, according to an embodiment.

In an embodiment and referring to FIG. 8, the sub-pixel SP may have the light emitting element LD and the sub-pixel circuit SPC for controlling a current amount supplied to the light emitting element LD.

Since the sub-pixel SP, according to an embodiment, is substantially the same as a configuration of the sub-pixel SP of FIG. 2, except for the second capacitor C2, the same reference numbers and reference symbols are used for the same or similar components, and overlapping descriptions is omitted.

In an embodiment, the second capacitor C2 may include a first electrode connected to the third node N3 and a second electrode receiving a reference voltage VREF, where the reference voltage VREF may be less than the first power voltage ELVDD and greater than the second power voltage ELVSS.

That is, in an embodiment, the second capacitor C2 may be connected between the third node N3 and a node receiving the reference voltage VREF.

In an embodiment, each of the capacitors C1 to C3 may be configured as an MOM capacitor or an MIM capacitor.

In an embodiment, each of the capacitors C1 and C2 may be configured as an MOM capacitor or an MIM capacitor, and the third capacitor C3 may be configured as a parasitic capacitor.

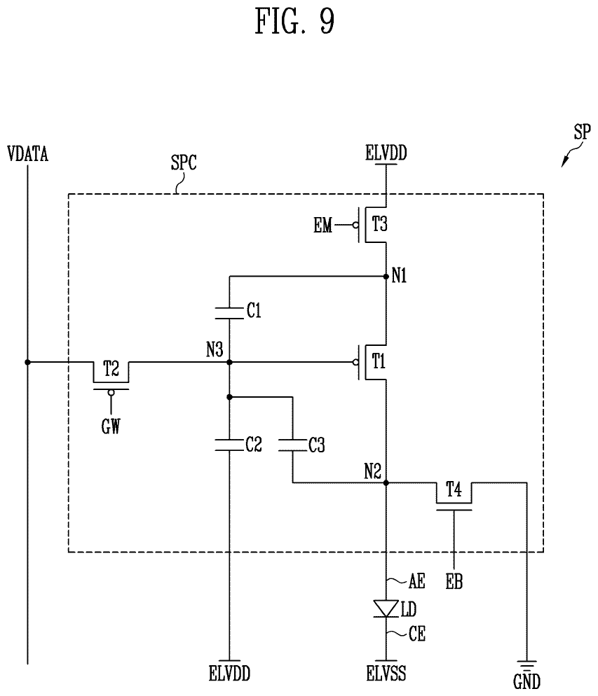

FIG. 9 is a circuit diagram illustrating another example of the sub-pixel of the display device of FIG. 1, according to an embodiment.

In an embodiment and referring to FIG. 9, the sub-pixel SP may include the light emitting element LD and the sub-pixel circuit SPC for controlling a current amount supplied to the light emitting element LD.

The sub-pixel SP, according to an embodiment, is substantially the same as a configuration of the sub-pixel SP of FIG. 2, except for the second capacitor C2, and thus the same reference numbers and reference symbols are used for the same or similar components, and an overlapping description is omitted.

In an embodiment, the second capacitor C2 may include a first electrode connected to the third node N3 and a second electrode receiving the first power voltage ELVDD.

That is, the second capacitor C2 may be connected between the third node N3 and a node receiving the first power voltage ELVDD.

In an embodiment, each of the capacitors C1 to C3 may be configured as an MOM capacitor or an MIM capacitor.

In an embodiment, each of the capacitors C1 and C2 may be configured as an MOM capacitor or an MIM capacitor, and the third capacitor C3 may be configured as a parasitic capacitor.

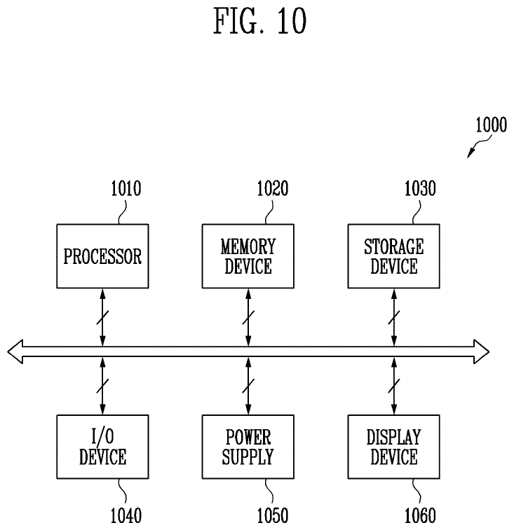

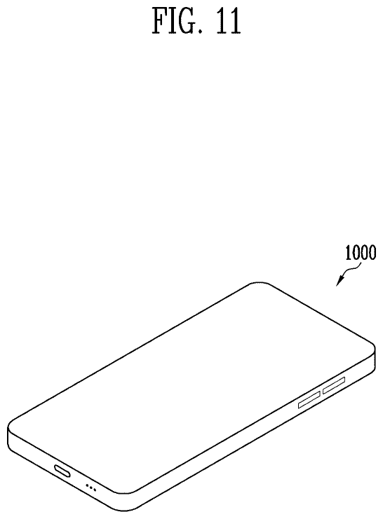

FIG. 10 is a block diagram illustrating an electronic device, according to an embodiment, and FIG. 11 is a diagram illustrating an example in which the electronic device of FIG. 10 is implemented as a smartphone, according to an embodiment.

In an embodiment and referring to FIGS. 10 and 11, the electronic device 1000 may include a processor 1010, a memory device 1020, a storage device 1030, an input/output device 1040, a power supply 1050, and a display device 1060. At this time, the display device 1060 may be the display device of FIG. 1. In addition, the electronic device 1000 may further include several ports capable of communicating with a video card, a sound card, a memory card, a USB device, or the like, or communicating with other systems. In an embodiment, as shown in FIG. 11, the electronic device 1000 may be implemented as a smart phone. However, this is exemplary, and the electronic device 1000 is not limited thereto. For example, in another embodiment, the electronic device 1000 may be implemented as a mobile phone, a video phone, a smart pad, a smart watch, a tablet PC, a vehicle navigation device, a computer monitor, a notebook computer, a head mounted display device, or the like.

The processor 1010 may perform specific calculations or tasks. According to an embodiment, the processor 1010 may be a microprocessor, a central processing unit, an application processor, or the like. The processor 1010 may be connected to other components through an address bus, a control bus, a data bus, or the like. According to an embodiment, the processor 1010 may also be connected to an expansion bus such as a peripheral component interconnect (PCI) bus.

In an embodiment, the memory device 1020 may store data necessary for an operation of the electronic device 1000. For example, the memory device 1020 may include a non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM), and a ferroelectric random access memory (FRAM) device, a volatile memory device such as a dynamic random access memory (DRAM) device, a static random access memory (SRAM) device, and a mobile DRAM device, and/or the like.

In an embodiment, the storage device 1030 may include a solid state drive (SSD), a hard disk drive (HDD), a CD-ROM, and the like.

In an embodiment, the input/output device 1040 may include an input means such as a keyboard, a keypad, a touch pad, a touch screen, and a mouse, and an output means such as a speaker and a printer. According to an embodiment, the display device 1060 may be included in the input/output device 1040.

In an embodiment, the power supply 1050 may supply power necessary for an operation of the electronic device 1000. For example, the power supply 1050 may be a power management integrated circuit (PMIC).

In an embodiment, the display device 1060 may display an image corresponding to visual information of the electronic device 1000. At this time, the display device 1060 may be an organic light emitting display device or a quantum dot light emitting display device, but is not limited thereto. The display device 1060 may be connected to other components through the buses or other communication links.

The scope of the invention should not be limited to the contents described in the specification. Example embodiments have been disclosed herein, and although specific terms are employed, they are used and are to be interpreted in a generic and descriptive sense only and not for purpose of limitation. In some instances, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the invention. Thus, while various embodiments have been described above, those skilled in the art will appreciate that various modifications, additions and substitutions are possible, without departing from the scope and spirit of the invention.

What is claimed is:

1. A sub-pixel comprising:
a first transistor connected between a first node, receiving a first power voltage, and a second node, including a control electrode connected to a third node, and generating a driving current;
a second transistor providing a data voltage to the third node in response to a first gate signal;
a third transistor providing a ground voltage to the second node in response to a second gate signal; and
a light emitting element emitting light by receiving the driving current, and including a first electrode connected to the second node and a second electrode receiving a second power voltage,
wherein the third transistor is configured as an NMOS transistor.

2. The sub-pixel according to claim 1, further comprising:
a fourth transistor providing the first power voltage to the first node in response to an emission signal.

3. The sub-pixel according to claim 2, further comprising:
a first capacitor connected between the first node and the third node;
a second capacitor connected between the third node and a gate electrode of the third transistor; and
a third capacitor connected between the second node and the third node.

4. The sub-pixel according to claim 3, wherein each of the first to third capacitors are configured as a metal-oxide metal (MOM) capacitor or a metal-insulator-metal (MIM) capacitor.

5. The sub-pixel according to claim 3, wherein each of the first and second capacitors are configured as a metal-oxide metal (MOM) capacitor or a metal-insulator-metal (MIM) capacitor, wherein
the third capacitor is configured as a parasitic capacitor.

6. The sub-pixel according to claim 3, wherein each of the first transistor, the second transistor, and the fourth transistors is configured as a PMOS transistor.

7. The sub-pixel according to claim 6, wherein the first power voltage is supplied to a body electrode of each of the first transistor, the second transistor, and the fourth transistor, wherein
the ground voltage is supplied to a body electrode of the third transistor.

8. The sub-pixel according to claim 3, wherein one horizontal period includes a first period, a second period, and a third period, wherein
each of the second to fourth transistors is turned on during the first period,
the second transistor and the third transistor are turned on and the fourth transistor is turned off during the second period, and
the third transistor and the fourth transistor are turned on and the second transistor is turned off during the third period.

9. The sub-pixel according to claim 2, further comprising:
a first capacitor connected between the first node and the third node;
a second capacitor connected between the third node and a node receiving a reference voltage; and
a third capacitor connected between the second node and the third node, wherein the reference voltage is less than the first power voltage and greater than the second power voltage.

10. The sub-pixel according to claim 2, further comprising:
a first capacitor connected between the first node and the third node;
a second capacitor connected between the third node and a node receiving the first power voltage; and
a third capacitor connected between the second node and the third node.

11. A display device comprising:
a display panel including a sub-pixel; and
a display panel driver configured to drive the display panel,
wherein the sub-pixel comprises:
a first transistor connected between a first node, receiving a first power voltage, and a second node, including a control electrode connected to a third node, and generating a driving current;
a second transistor providing a data voltage to the third node in response to a first gate signal;
a third transistor providing a ground voltage to the second node in response to a second gate signal; and
a light emitting element emitting light by receiving the driving current, and including a first electrode connected to the second node and a second electrode receiving a second power voltage, wherein
the third transistor is configured as an NMOS transistor.

12. The display device according to claim 11, wherein the sub-pixel further comprises a fourth transistor providing the first power voltage to the first node in response to an emission signal.

13. The display device according to claim 12, wherein the sub-pixel further comprises:
a first capacitor connected between the first node and the third node;
a second capacitor connected between the third node and a gate electrode of the third transistor; and
a third capacitor connected between the second node and the third node.

14. The display device according to claim 13, wherein each of the first to third capacitors is configured as a metal-oxide metal (MOM) capacitor or a metal-insulator-metal (MIM) capacitor.

15. The display device according to claim 13, wherein each of the first and second capacitors is configured as a metal-oxide metal (MOM) capacitor or a metal-insulator-metal (MIM) capacitor, wherein
the third capacitor is configured as a parasitic capacitor.

16. The display device according to claim 13, wherein each of the first transistor, the second transistor, and the fourth transistor is configured as a PMOS transistor.

17. The display device according to claim 16, wherein the first power voltage is supplied to a body electrode of each of the first transistor, the second transistor, and the fourth transistor, wherein
the ground voltage is supplied to a body electrode of the third transistor.

18. The display device according to claim 13, wherein one horizontal period includes a first period, a second period, and a third period, wherein
each of the second to fourth transistors is turned on during the first period,
the second transistor and the third transistor are turned on and the fourth transistor is turned off during the second period, and
the third transistor and the fourth transistor are turned on and the second transistor is turned off during the third period.

19. The display device according to claim 12, wherein the sub-pixel further comprises:
a first capacitor connected between the first node and the third node;
a second capacitor connected between the third node and a node receiving a reference voltage; and
a third capacitor connected between the second node and the third node, wherein
the reference voltage is less than the first power voltage and greater than the second power voltage.

20. An electronic device comprising:
a display device including a display panel including a sub-pixel; and
a display panel driver configured to drive the display panel,
wherein the sub-pixel comprises:
a first transistor connected between a first node, receiving a first power voltage, and a second node, including a control electrode connected to a third node, and generating a driving current;
a second transistor providing a data voltage to the third node in response to a first gate signal;
a third transistor providing a ground voltage to the second node in response to a second gate signal; and
a light emitting element emitting light by receiving the driving current, and including a first electrode connected to the second node and a second electrode receiving a second power voltage, wherein
the third transistor is configured as an NMOS transistor.
